(19) United States
(12) Patent Application Publication
(10) Pub. No.: US 2015/0355030 A1
(43) Pub. Date: Dec. 10, 2015

(54) EQUIPMENT AND METHOD FOR INTENSITY-TEMPERATURE TRANSFORMATION OF IMAGING SYSTEM

(71) Applicant: Honeywell International Inc., Morristown, NJ (US)

(72) Inventors: Kwong Wing Au, Bloomington, MN (US); Sharath Venkatesha, Minnetonka, MN (US)

(21) Appl. No.: 14/296,286

(22) Filed: Jun. 4, 2014

(51) Int. Cl. G01J 5/00; G01J 5/10

(52) U.S. Cl. CPC G01J 5/0044; G01J 5/10; G01J 2005/0077; G01J 2005/0048

(57) ABSTRACT

A process is provided for estimating temperatures in an enclosure during a combustion process. An association is determined between an intensity of an image pixel of a field of view (FOV) generated by an image-capturing device, a temperature measurement, and device settings of the image-capturing device. An on-line intensity-temperature calibration is performed based on the association between the intensity of the image pixel and the corresponding temperature in the FOV in the enclosure. The intensity of the corresponding image is transformed to the temperature based on intensity-temperature calibration related to the device settings of the image-capturing device. Using a computer processor, the need for maintenance of the image-capturing device is determined based on degradation of the intensity-temperature calibration.

The present invention relates generally to a process for transforming image intensity to temperature, and more particularly to a process for on-line transformation of the image intensity to temperature readings of a furnace enclosure.

### BACKGROUND OF THE INVENTION

Accurately analyzing internal conditions of a furnace is an essential task for an operator to better control temperatures of different regions in a furnace enclosure for producing products more efficiently and saving energy-related costs. Typically, image-capturing devices, such as color cameras, infrared spectrometers, filtered cameras, and the like, are installed in the furnace enclosure for detecting the temperatures of the furnace enclosure. Intensities of image pixels received from the devices have a direct relationship with the temperatures of viewed surfaces inside the furnace.

Calibration is performed to establish this relationship between the temperatures and intensities. Typically, the calibration is based on an off-line process, which is performed infrequently. Once the calibration is performed, the intensity to temperature relationship is fixed, and does not get updated until the next calibration process, which can be as long as a year. Further, responses of the image-capturing devices are often unstable in high-temperature and dynamic operating conditions. For example, the devices or cameras can suffer from unwanted movement and vibrations of the furnace, and/or repeated expansions and contractions of the furnace enclosure due to temperature changes. As a result, accurately detecting and estimating the temperature and thermal radiance fields of the furnace enclosure is a challenging task for the operator.

Typically, the off-line intensity-temperature calibration is performed based on an infrequent and inadequately updated off-line process. Further, the image-capturing device response becomes unstable in high-temperature, dynamic operating conditions. Consequently, the unstable response renders errors related to intensity-temperature transformation due to the stale off-line calibration. Further, high fidelity temperature sensors are expensive and require complicated installation steps due to the operating conditions of the furnace.

Therefore, there is a need for an improved method of performing the intensity-temperature transformation of an imaging system that is cost-effective and uncomplicated without generating substantial errors or variations during the combustion process of the furnace.

### BRIEF SUMMARY OF THE INVENTION

The present invention is directed to a process for on-line transformation of the image intensity to temperature readings of a furnace enclosure using temperature sensors.

An important feature of certain embodiments is that the present process performs on-line transformation of the image intensity generated by image-capturing devices to the temperature readings using an imaging system having one or more image-capturing devices and only few temperature sensors. Temperature measurement is often a prerequisite for many optimal industrial controls. This is particularly true in an industrial furnace, which is a large enclosure heated by multiple burners. The temperature sensors, such as thermal couples and pyrometers, are used to measure the temperature of the furnace. However, the temperature sensors can measure only certain areas of the furnace where the sensors are installed, and thus the remaining surfaces and volumes cannot be measured without the sensors.

It is an important task for an operator to effectively perform temperature measurements of the entire furnace for maximum product yield, maximum energy efficiency, and minimum flue gas emitted. An image-capturing device generates a light intensity image of a selected region of the furnace. Transformation of the light intensity to a temperature reading is needed. Off-line calibration of the image-capturing device is often performed. The off-line calibration process captures intensity images of a black body at multiple temperatures with the image-capturing device at different camera settings. Based on the off-line calibration, relationships between the intensities and the temperatures can be established. However, as discussed below, this off-line calibration causes inaccurate and imprecise temperature outputs.

Typically, the black body has ideal emissivity and reflectivity. On the contrary, characteristics of furnace surfaces, which are composed of various non-black materials, differ from the characteristics of the black body. Further, distances from the image-capturing devices to the furnace surfaces could also differ from the distances utilized during the off-line calibration. The transmissivities along viewing paths of the image-capturing devices also differ. Thus, applying the off-line calibration creates an indeterminate error. The off-line calibration is infrequently performed, and thus is insufficient for adapting to the changes of the temperature sensor responses. Often, the off-line calibration is performed at an isolated location, and therefore requires complicated and labor-intensive uninstallation (and subsequent re-installation) of the image-capturing devices.

Moreover, the image-capturing devices are exposed to the harsh operating environment of the furnace, and their responses to radiation inside the furnace can degrade rapidly when compared to an off-line calibration frequency. Applying a stale calibration function to the temperature sensor response generates incorrect temperature readings. Further, the transmission of radiation through the lenses of the image-capturing devices also affects the intensity outputs. Thus, dirty lenses of the image-capturing devices can cause erroneous temperature readings if the degraded radiation transmission is not accounted for during the off-line calibration. Accordingly, as described in greater detail below, the present process provides an online calibration that resolves these drawbacks and generates accurate and precise temperature readings of the furnace enclosure using a temperature estimation propagation method. Further, the present process can notify the operator on the required maintenance of imaging equipment.

The foregoing and other aspects and features of the present invention will become apparent to those of reasonable skill in the art from the following detailed description, as considered in conjunction with the accompanying drawings.

### BRIEF DESCRIPTION OF THE DRAWINGS

FIG. 1 illustrates an exemplary use of the present process in a camera system configuration;

FIG. 2 is a functional block diagram of the present process featuring functional units in accordance with an embodiment of the present disclosure; and

FIG. 3 illustrates an exemplary temperature estimation propagation method in accordance with an embodiment of the present disclosure.

### DETAILED DESCRIPTION OF THE INVENTION

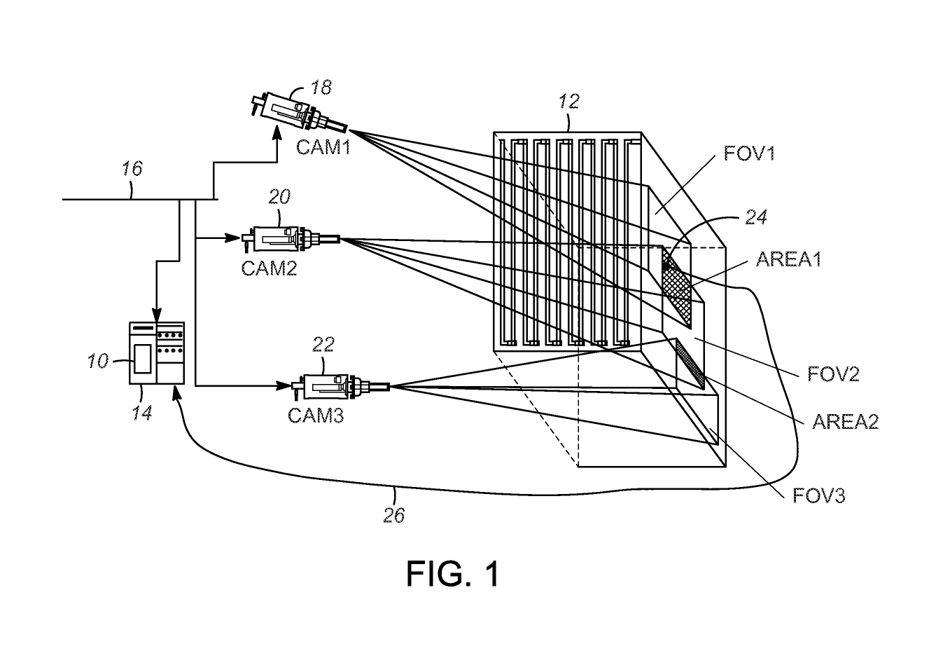

Referring now to FIG. 1, an exemplary estimation unit 10 using an embodiment of the present process is provided for accurately estimating temperatures of regions that are viewed by multiple image-capturing devices 18, 20, 22 inside a large scale enclosure 12, such as an industrial furnace. As used herein, the term “unit” may refer to, be part of, or include an Application Specific Integrated Circuit (ASIC), an electronic circuit, a computer processor (shared, dedicated, or group) and/or memory (shared, dedicated, or group) that executes one or more software or firmware programs, a combinational logic circuit, and/or other suitable components that provide the described functionality. Thus, while this disclosure includes particular examples and arrangements of the units, the scope of the present system should not be so limited since other modifications will become apparent to the skilled practitioner.

The estimation unit 10 may reside in or be coupled to a server or computing device 14 (including, e.g., database and video servers), and is programmed to perform tasks and display relevant data for different functional units via a network 16. It is contemplated that other suitable networks can be used, such as a corporate Intranet, a local area network (LAN) or a wide area network (WAN), and the like, using dial-in connections, cable modems, high-speed ISDN lines, and other types of communication methods known in the art. All relevant information can be stored in the databases for retrieval by the estimation unit 10 or the computing device 14 (e.g., as a data storage device and/or a machine readable data storage medium carrying computer programs). An exemplary estimation unit 10 is disclosed in commonly assigned U.S. patent application Ser. No. ______ (Attorney Docket No. 5066.116932), which is incorporated by reference in its entirety.

A plurality of image-capturing devices 18, 20, 22 are mounted around the enclosure 12 (with three devices being shown in this example, but with additional devices being included, if desired). A single image-capturing device may not capture the entire enclosure 12 due to its limited field of view. Each of the image-capturing devices 18, 20, 22 captures image sequences covering a selected interior portion or region of the enclosure 12, for which temperature is to be measured. A plurality of temperature sensors 24 (only one of which is shown in FIG. 1), such as thermal couples or pyrometers, which are each observable by one or more image-capturing devices 18, 20, are placed inside the enclosure 12. Although only three image-capturing devices 18, 20, 22 and one temperature sensor 24 are shown for illustration purposes, any number of devices and sensors can be used.

To reduce a total number of temperature sensors installed in the enclosure 12, the first image-capturing device (CAM1) 18 shares the temperature sensor 24 with the second image-capturing device (CAM2) 20 such that the sensor is selectively positioned in a first common overlapping area AREA1 of a first field of view (or FOV) FOV1 of CAM1 18 and a second field of view FOV2 of CAM2 20. Although a third field of view FOV3 of the third image-capturing device (CAM3) 22 does not have a temperature sensor 24, the FOV3 has a second common overlapping area AREA2 shared with the FOV2. As explained in greater detail below, the estimation unit 10 utilizes a temperature estimation propagation method to estimate temperatures of FOV3 outside of the AREA2 based on the temperature measured in the FOV2.

A cable 26 (or other signal transferring means, such as wireless communication) may be used to connect the sensor 24 to the computing device 14, which may also have digitization, storage, and user interface capabilities. The computing device 14 receives temperature outputs or signals from the temperature sensor 24 and image sequences from the image-capturing devices 18, 20, 22 to set proper parameters of the image-capturing devices for performing subsequent intensity-temperature calibration and estimating the temperature of the selected region of the enclosure 12.

In one embodiment, temperatures are computed and estimated from a set of intensity images, which are captured by optimally placed image-capturing devices 18, 20, 22 in the enclosure 12. As shown in FIG. 1, the plurality of image-capturing devices 18, 20, 22 are positioned with respect to the enclosure 12 so that their corresponding FOVs are positioned inside the enclosure 12, and the plurality of thermal couples or pyrometers 24 are disposed at selected locations of the enclosure for collecting data. The estimation unit 10 calculates and determines the temperatures of the selected regions of the enclosure 12 based on the collected data. More detailed descriptions of certain features of the present process are provided below.

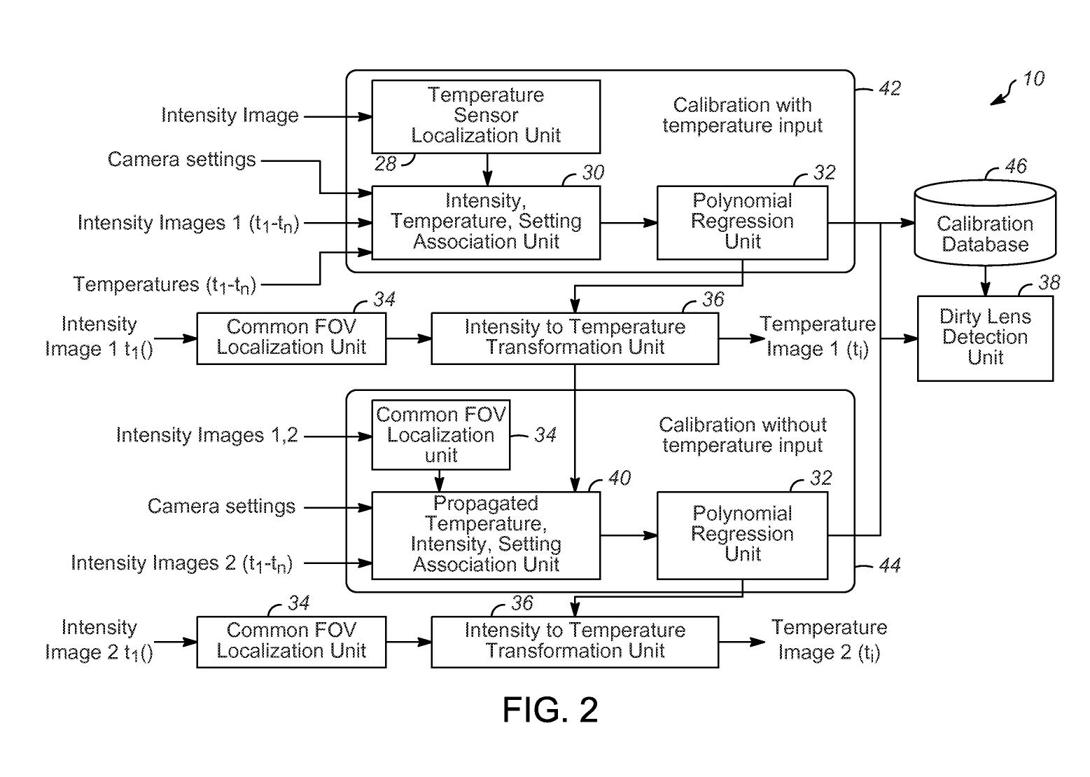

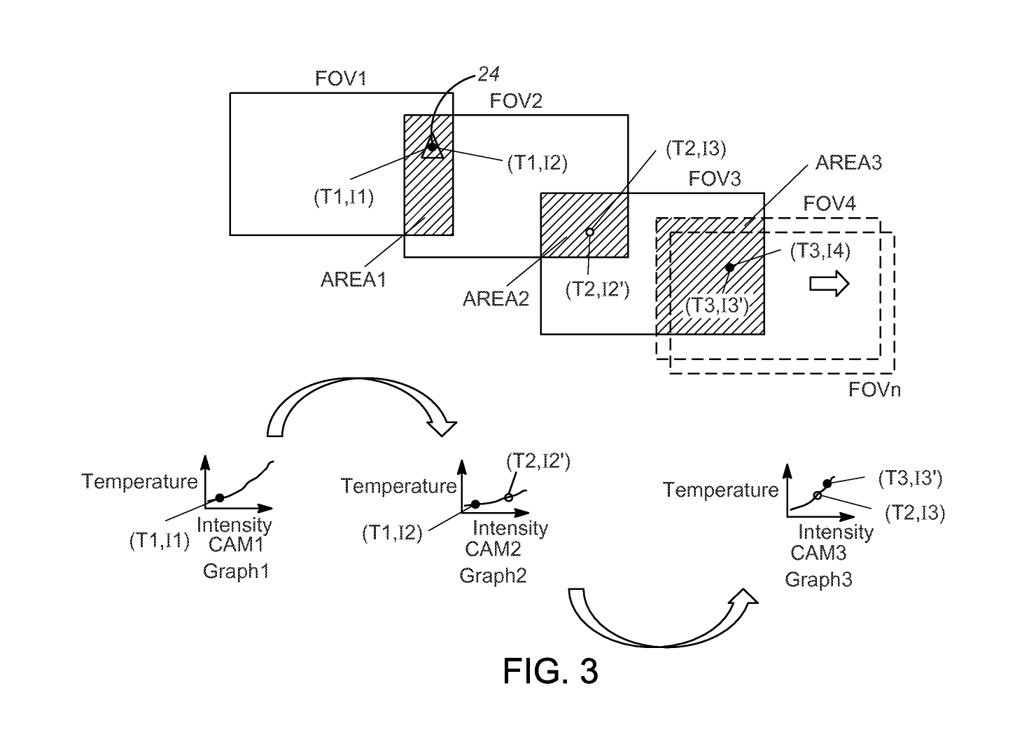

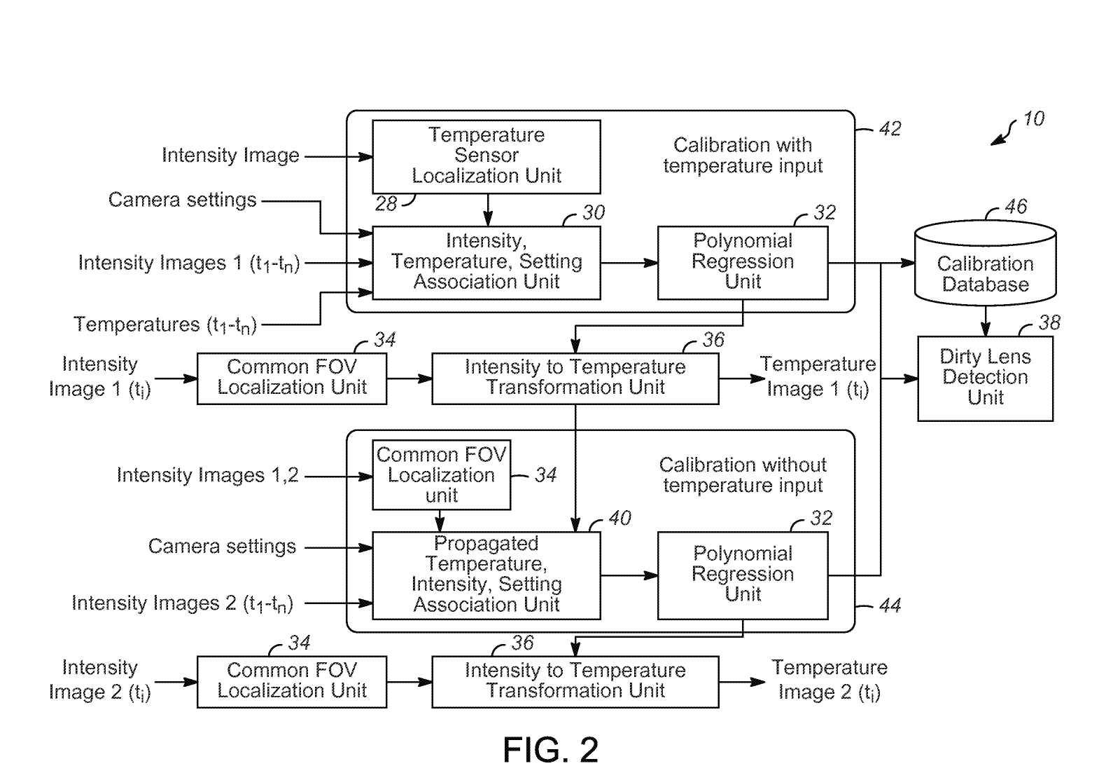

Referring now to FIG. 2, an explanation will be provided of how the estimation unit 10, of this embodiment, provides a method for on-line intensity-temperature calibration and for signaling that system maintenance is needed when it has been detected that one (or more) of the image-capturing devices 18, 20, 22 has a dirty window or camera lens. Included in the estimation unit 10 are a calibration with temperature input unit 42, a calibration without temperature input unit 44, a common FOV localization unit 34, an intensity to temperature transformation unit 36, and a dirty lens detection unit 38. The temperature calibration with temperature input unit 42 further includes a temperature sensor localization unit 28; an intensity, temperature, setting association unit 30; and a polynomial regression unit 32. The temperature calibration without temperature input unit 44 further includes a common FOV localization unit 34; a propagated temperature, intensity, setting association unit 40; and a polynomial regression unit 32.

The calibration with temperature input unit 42 computes the intensity to temperature calibration using the temperature inputs from temperature sensor 24 and images from image-capturing devices 18, and 20. The temperature sensor localization unit 28 determines the pixel locations (x, y coordinates) of the temperature sensor 24 in the images captured by the image capture devices 18 and 20. A group of pixels can be associated with the location of the temperature sensor. Since temperature sensor 24 is not within the FOV of device 22, temperature sensor localization unit 28 does not apply to device 22. Determination of the locations can be done once based on inputs from the user, who labels the locations of the sensor 24 in the images. In another embodiment, the calibration with temperature input unit 42 computes the locations using the physical locations of the temperature sensor, the geometrical properties of the furnace and the configuration and properties of the cameras, such as the FOV, image dimension and the like.

A dynamic range of image pixel values is limited to a number of bits per pixel. For example, if the number of bits per pixel in a camera is equal to 8, the camera can measure 2⁸ (or 256) distinct temperature values. Typically, the temperature of the combustion process can reach up to 2500 degree Fahrenheit (or ° F.) or 1400 degree Celsius (or ° C.). To cover an entire temperature range (e.g., 0-2500° F. or 0-1400° C.), the device parameters or settings, such as aperture, shutter, and gain, can be selectively set and adjusted. Thus, various intensity-temperature calibration functions are established based on specific camera settings.

The intensity, temperature, setting association unit 30 assembles sets of pairs of intensity and its corresponding temperature for image-capturing devices 18 and 20. Each set corresponds to one specific set of camera settings of one image-capturing device. Given the sensor locations in the image from unit 28, the intensities of the sensor pixels can be extracted from the image. If multiple pixels are assigned to a sensor location, an intensity estimate can be computed based on smoothing/filtering process, such as average, median, weighed sum etc. The actual temperature can be acquired from the temperature sensor 24. Thus a pair of intensity-temperature is collected. A set of these pairs ((i₁, T₁), (i₂, T₂), (i₃, T₃), . . . , (iᵢ, Tᵢ), . . . (iₙ, Tₙ) can be assembled in real-time from time t₁ to tₙ during the furnace operation, each associated with intensity iᵢ at a different temperature value Tᵢ. Alternatively, in another embodiment, multiple temperature sensors similar to the sensor 24 can be placed within the FOV of the image-capturing device to get intensity-temperature pairs from a single image captured at time tᵢ.

The polynomial regression unit 32 utilizes a polynomial regression method to compute the transformation or function from intensity to temperature using the set of intensity, temperature, setting associations. The polynomial regression method is done by performing a least square error or approximation. Other suitable weighted, least-square based polynomial regression methods are also contemplated to suit different applications. It is contemplated that the polynomial regression unit 32 also performs on-line this intensity-temperature calibration function. Based on the mapped temperature and intensity values, the polynomial regression unit 32 generates a function between the temperature and the intensity (see, Graphs 1-3 in FIG. 3). Each of a spectral band of the image-capturing devices 18, 20, 22 can be calibrated using this on-line method. As an example, a red, green and blue channel of a color video camera can each have its own calibration functions. Historical records of the intensity-temperature calibration are stored in a storage device.

As discussed above, each installation of the temperature sensor 24 can be expensive due to the high price of such sensors and required cabling (or other communication means) between the sensors and the computing device 14. Thus, it is desirable to minimize the number of temperature sensors 24 and the cables 26 for the furnace enclosure 12. In a preferred embodiment, the single temperature sensor 24 is shared by at least two image-capturing devices, namely the first and second devices 18, 20 (i.e., CAM1 and CAM2).

As shown in the FIG. 1 embodiment, the temperature sensor 24 can be shared by the first and second image-capturing devices 18, 20. It is preferred that the temperature sensor 24 is disposed in an area that is within a common field of view of the image-capturing devices 18, 20. The first and second image-capturing devices 18, 20 may have different device settings to cover different ranges of temperatures in their corresponding FOVs.

Some image-capturing devices, such as the device 22, do not have a temperature sensor 24 within their FOVs. However, the calibration is still needed for the intensity to temperature transformation. The Calibration Without Temperature Input unit 44 computes the calibration without input from a temperature sensor 24 but using temperature estimates propagated from other temperature images,

The common FOV localization unit 34 determines the pixels in two images that have the same physical locations of the enclosure. These two images are acquired by the image-capturing devices 18, 20, 22. The present process involves well-established three dimensional geometric computations using the geometrical properties of the furnace and the configuration and properties of the cameras, such as the FOV, image dimension etc. Many-pixels-to-one-pixel, one-pixel-to-many-pixels or one-pixel-to-one-pixel correspondences are possible, depending on the relative viewing aspects of the devices 18, 20, 22.

The propagated temperature, intensity, setting association unit 40 assembles sets of pairs of intensity and its corresponding temperature for image-capturing device 22. Each set corresponds to one specific camera settings of image-capturing device 22. The intensities to be associated with are from those common pixels that are identified by the common FOV localization unit 34. The corresponding temperatures of these pixels are derived from the common pixels in the temperature image from image capturing device 20. In the cases of many-to-one and one-to-many common pixel correspondence, averaging, median selection or other filtering methodscan be applied to obtain a one-to-one intensity to temperature association. Then the polynomial regression unit 32 computes the intensity-temperature calibration function for the image-capturing device 22.

The on-line calibration is performed by mapping the temperature outputs or readings received from the temperature sensor 24 and the corresponding pixel intensities received from the image-capturing devices 18, 20, 22. After the mapping, the intensities can be converted to temperature values based on the on-line calibration results. Historical records of the intensity-temperature calibration are stored in a storage device, and subsequently compared by the intensity, temperature, setting association unit 30. Thus, when the responses from the image-capturing devices 18, 20, 22 are degraded, or the lenses of the devices become dirty, the intensity-temperature calibration values become different from the original or initial values stored in the storage device. When the difference exceeds a predetermined threshold (e.g., 15%) in this example, an indicator is flagged to signal that system maintenance is required.

The intensity to temperature transformation unit 36 transforms the intensities of the corresponding image to the temperatures based on the device settings of the image-capturing device and the appropriate calibration function. Because the pixels within the common FOV in AREA1 correspond to the same physical area of the furnace, the pixels should have same temperature outputs in image-capturing devices 18, 20 and 22. A conflict resolution method can be applied to resolve the temperature differences and update the calibration functions producing more consistent temperature images. Furthermore, in certain embodiments, based on the same temperatures in common FOVS, a chain of propagation can effectively deduce or estimate the temperatures of the adjacent FOV2 and FOV3.

The dirty lens detection unit 38 detects and alerts that the lens of the image-capturing devices 18, 20 and 22 is dirty based on the degradation in the calibration function. Historical records of the intensity-temperature calibration are stored in a storage device, and subsequently compared by the dirty lens detection unit 38. Thus, when the responses from the image-capturing devices 18, 20, 22 are degraded, or the lenses of the devices become dirty, the intensity-temperature calibration values become lower from the original or initial values stored in the storage device. When the difference exceeds a predetermined threshold (e.g., 15%) in this example, an indicator is flagged to signal that system maintenance is required. The predetermined threshold is application specific and can be set by an operator

Referring now to FIG. 3, an exemplary temperature estimation propagation method is shown. The first and second image-capturing devices 18, 20 (i.e., CAM1 and CAM2) that have a common field of view AREA1 can propagate the intensity-temperature calibration in FOV1 to other FOVs, namely FOV2, FOV3, FOV4, and FOVn. The corresponding image-capturing devices CAM1, CAM2, CAM3, and CAMn have different device settings. When the first image-capturing device CAM1 18 establishes the intensity-temperature calibration for FOV1 either directly based on the temperature readings or outputs from the sensor 24, or indirectly from propagation, the second and third image-capturing devices CAM2 20 and CAM3 22 can further establish the intensity-temperature calibration for FOV2 based on the calibration of FOV1.

As discussed above, the polynomial regression unit 32 performs the on-line intensity-temperature calibration function by mapping the temperature and the corresponding intensity of the image pixel of the selected FOV. Based on the mapped temperature and intensity values, the polynomial regression unit 32 generates the relationship between the temperature and the intensity. For example, Graph1 illustrates the relationship between the temperatures measured and the intensities captured in FOV1 of CAM1. Similarly, Graph2 illustrates the calibration relationship in FOV2 of CAM2, and Graph3 illustrates the relationship in FOV3 of CAM3.

A plurality of temperature-intensity pairs are created for generating the calibration relationship by the polynomial regression unit 32. For example, the temperature reading T1 is received from the temperature sensor 24 that is selectively positioned in the first common overlapping area AREA1 shared by FOV1 of CAM1 and FOV2 of CAM2. Because the device settings may be different between CAM1 and CAM2, two different intensities I1 and I2 may represent the same temperature T1 as two different temperature-intensity pairs, namely (T1, I1) and (T1, I2).

Using other temperature-intensity pairs calculated in AREA1 of FOV1, the polynomial regression unit 32 generates the calibration relationship Graph1. Likewise, the calibration relationship Graph2 is generated using the pairs calculated in AREA1 of FOV2, having different intensity values than Graph1. Thus, the temperature-intensity pair (T2, I2′) in AREA2 of FOV2 can be deduced based on the calibration relationship Graph2. Because the temperature T2 has the same value in AREA2 of FOV3, the temperature-intensity pair (T2, I3) can be used for calibrating areas outside of AREA2 of FOV3. Accordingly, the calibration relationship Graph3 is generated using the pairs calculated in AREA2 of FOV3, having different intensity values than Graph1 and Graph2.

As is the case with FOV2, the temperature-intensity pair (T3, I3′) in AREA3 of FOV3 can be deduced based on the calibration relationship Graph3. Again, because the temperature T3 has the same value in AREA3 of FOV4, the temperature-intensity pair (T3, I4) can be used for calibrating areas outside of AREA3 of FOV4. The calibration without temperature input unit 44 iteratively performs this propagation method to estimate the temperatures in the n-th field of view FOVn of the n-th image-capturing device CAMn.

While a particular embodiment of the present estimation process has been described herein, it will be appreciated by those skilled in the art that changes and modifications may be made thereto without departing from the invention in its broader aspects and as set forth in the following claims.

What is claimed is:

1. A process for estimating temperatures in an enclosure during a combustion process, comprising:
determining an association between an intensity of an image pixel of a field of view (FOV) generated by an image-capturing device, a temperature measurement, and device settings of the image-capturing device;
performing an on-line intensity-temperature calibration based on the association between the intensity of the image pixel and the corresponding temperature in the FOV in the enclosure;
transforming the intensity of the corresponding image to the temperature based on intensity-temperature calibration related to the device settings of the image-capturing device; and
determining, using a computer processor, the need for maintenance of the image-capturing devices based on degradation of the intensity-temperature calibration.

2. The process according to claim 1, wherein the temperature measurement is acquired from a temperature sensor.

3. The process according to claim 1, wherein the temperature measurement is inferred from a temperature image that has a common field of view with the image of interest.

4. The process according to claim 1, further comprising:
maintaining historical records of the intensity-temperature calibration in a storage device;
calculating a difference between an original intensity-temperature calibration value associated with the image pixel, and a current intensity-temperature calibration value; and
indicating that system maintenance is required when the difference exceeds a predetermined threshold.

5. The process according to claim 1, further comprising:
disposing a temperature sensor in an area that is within a common field of view of at least two image-capturing devices having different device settings; and
minimizing the temperature estimation error based on temperature consistency in the common FOV.

6. The process according to claim 5, further comprising:
generating a calibration relationship between the temperatures and the intensities of the image pixels in the common field of view based on values of the temperatures, intensities and the device settings.

7. The process according to claim 6, further comprising:
estimating the temperatures of the FOV based on the functional relationship between the temperatures and the intensities of the image pixels in the common field of view.

8. The process according to claim 6, further comprising:
estimating the temperatures of adjacent FOVs, wherein the adjacent FOVs lack a temperature sensor therein, by propagating the temperature into the adjacent FOVs based on the temperatures in the common field of view.

9. An apparatus for estimating temperatures in an enclosure, the apparatus comprising:
an intensity, temperature, setting association unit configured for determining an association between an intensity of an image pixel of a field of view (FOV) generated by an image-capturing device, a temperature measurement, and device settings of the image-capturing device,
wherein the intensity, temperature, setting association unit performs an on-line intensity-temperature calibration based on the association between the intensity of the image pixel and the corresponding temperature in the FOV in the enclosure;
an intensity-temperature transformation unit configured for transforming the intensity of the corresponding image to the temperature based on intensity-temperature calibration related to the device settings of the image-capturing device; and
a temperature estimation unit configured for determining, using a computer processor, the need for maintenance of the image-capturing devices based on degradation of the intensity-temperature calibration.

10. The apparatus according to claim 9, wherein the temperature measurement is acquired from a temperature sensor.

11. The apparatus according to claim 9, wherein the temperature measurement is inferred from a temperature image that has a common field of view with the image of interest.

12. The apparatus according to claim 9, wherein the intensity, temperature, setting association unit is configured for:
maintaining historical records of the intensity-temperature calibration in a storage device;
calculating a difference between an original intensity-temperature calibration value associated with the image pixel, and a current intensity-temperature calibration value; and
indicating that system maintenance is required when the difference exceeds a predetermined threshold.

13. The apparatus according to claim 9, wherein a temperature sensor is disposed in an area that is within a common field of view of at least two image-capturing devices having different device settings such that the temperature estimation error is minimized based on temperature consistency in the common FOV.

14. The apparatus according to claim 13, further including a polynomial regression unit configured for:
generating a calibration relationship between the temperatures and the intensities of the image pixels in the common field of view based on values of the temperatures, intensities and the device settings.

15. The apparatus according to claim 14, further comprising a propagated temperature, intensity, setting association unit configured for:
estimating the temperatures of the FOV based on the functional relationship between the temperatures and the intensities of the image pixels in the common field of view.

16. The apparatus according to claim 14, wherein the propagated temperature, intensity, setting association unit is configured for:
estimating the temperatures of adjacent FOVs, wherein the adjacent FOVs lack a temperature sensor therein, by propagating the temperature into the adjacent FOVs based on the temperatures in the common field of view.

17. A non-transitory computer-readable medium storing instructions executable by a processor to estimate temperatures in an enclosure during a combustion process, comprising instructions to:
determine an association between an intensity of an image pixel of a field of view (FOV) generated by an image-capturing device, a temperature measurement, and device settings of the image-capturing device;
perform an on-line intensity-temperature calibration based on the association between the intensity of the image pixel and the corresponding temperature in the FOV in the enclosure;
transform the intensity of the corresponding image to the temperature based on intensity-temperature calibration related to the device settings of the image-capturing device; and
determine, using a computer processor, the need for maintenance of the image-capturing devices based on degradation of the intensity-temperature calibration.

18. The medium according to claim 17, wherein the temperature measurement is acquired from a temperature sensor, and is inferred from a temperature image that has a common field of view with the image of interest.

19. The medium according to claim 17, further comprising instructions to:
maintain historical records of the intensity-temperature calibration in a storage device;
calculate a difference between an original intensity-temperature calibration value associated with the image pixel, and a current intensity-temperature calibration value; and
provide an indication that system maintenance is required when the difference exceeds a predetermined threshold.

20. The medium according to claim 17, wherein when the temperature sensor is disposed in an area that is within a common field of view of at least two image-capturing devices having different device settings, further comprising instructions to:
minimize the temperature estimation error based on temperature consistency in the common FOV;
generate a calibration relationship between the temperatures and the intensities of the image pixels in the common field of view based on values of the temperatures, intensities and the device settings;
estimate the temperatures of the FOV based on the functional relationship between the temperatures and the intensities of the image pixels in the common field of view; and
estimate the temperatures of adjacent FOVs, wherein the adjacent FOVs lack a temperature sensor therein, by propagating the temperature into the adjacent FOVs based on the temperatures in the common field of view.
